(19) United States
(12) Patent Application Publication
(10) Pub. No.: US 2026/0146544 A1
(43) Pub. Date: May 28, 2026

(54) CLEARANCE CONTROL SYSTEM FOR BLADE OUTER AIR SEAL

(71) Applicant: RTX Corporation, Farmington, CT (US)

(72) Inventors: Davis Hovey, Jupiter, FL (US); Griffin D. Lavine, South Glastonbury, CT (US)

(21) Appl. No.: 18/962,957

(22) Filed: Nov. 27, 2024

(51) Int. Cl. F01D 11/18

(52) U.S. Cl. CPC F01D 11/18

(57) ABSTRACT

An assembly is provided for a turbine engine. This assembly includes a carrier, a control ring and a bladed outer air seal mounted to the carrier. The carrier extends circumferentially around an axis. The carrier includes an annular cavity, a first section and a second section. The annular cavity is formed within the carrier by the first section and the second section. The first section is welded and/or brazed to the second section at a sealed full-hoop bond joint. The first section is further connected to the second section at a second sealed full-hoop joint. The control ring extends circumferentially around the axis within the annular cavity.

### BACKGROUND OF THE DISCLOSURE

### 1. Technical Field

This disclosure relates generally to a turbine engine and, more particularly, to a clearance control system for a blade outer air seal.

### 2. Background Information

A turbine engine may include a clearance control system for tailoring clearance between rotor blade tips and a blade outer air seal. Various types and configurations of clearance control systems are known in the art. While these known clearance control systems have various benefits, there is still room in the art for improvement.

### SUMMARY OF THE DISCLOSURE

According to an aspect of the present disclosure, an assembly is provided for a turbine engine. This assembly includes a carrier, a control ring and a bladed outer air seal mounted to the carrier. The carrier extends circumferentially around an axis. The carrier includes an annular cavity, a first section and a second section. The annular cavity is formed within the carrier by the first section and the second section. The first section is welded and/or brazed to the second section at a sealed full-hoop bond joint. The first section is further connected to the second section at a second sealed full-hoop joint. The control ring extends circumferentially around the axis within the annular cavity.

According to another aspect of the present disclosure, another assembly is provided for a turbine engine. This assembly includes a carrier and a control ring. The carrier extends circumferentially around an axis. The carrier includes a cavity, a first section and a second section. The cavity is formed within the carrier by the first section and the second section. The first section is welded and/or brazed to the second section at a sealed full-hoop bond joint. The first section is attached to the second section at an interference fit connection between the first section and the second section. The control ring extends circumferentially around the axis within the cavity.

According to still another aspect of the present disclosure, a method of manufacture is provided. This method includes: (a) arranging a control ring in a channel of a carrier first section; (b) arranging a carrier second section with the carrier first section, the carrier second section axially and radially engaging the carrier first section so as to self-fixture the carrier first section with the carrier second section for subsequent welding and/or brazing; and (c) welding and/or brazing the carrier second section to the carrier first section to provide a sealed full-hoop bond joint between the carrier second section and the carrier first section, wherein the control ring extends circumferentially around an axis within an annular cavity of a carrier. The cavity is formed within the carrier by the carrier first section and the carrier second section.

The carrier may fluidly separate the annular cavity from a plenum next to and/or around the carrier.

The first section may be radially adjacent the second section at the sealed full-hoop bond joint.

The first section may be axially adjacent the second section at the sealed full-hoop bond joint.

The sealed full-hoop bond joint may be radially outboard of the annular cavity.

The second sealed full-hoop joint may be radially inboard of the annular cavity.

The sealed full-hoop bond joint may be radially inboard of the annular cavity.

The second sealed full-hoop joint may be radially outboard of the annular cavity.

The second sealed full-hoop joint may be radially aligned with and to an axial side of the annular cavity.

The sealed full-hoop bond joint may be radially aligned with and to a first axial side of the annular cavity.

The second sealed full-hoop joint may be radially inboard of the annular cavity.

The second sealed full-hoop joint may be radially aligned with and to a second axial side of the annular cavity.

The first section may be welded and/or brazed to the second section at the second sealed full-hoop joint. The second sealed full-hoop joint may be a second sealed full-hoop bond joint.

The second sealed full-hoop joint may be configured as or otherwise include a lap joint between the first section and the second section.

The second sealed full-hoop joint may be configured as or otherwise include an interference fit connection between the first section and the second section.

The second section may axially overlap the first section at the second sealed full-hoop joint.

The first section may include a first inner flange, a first outer flange and a first web extending radially between and connected to the first inner flange and the first outer flange. The annular cavity may extend axially within the carrier to the first web. The annular cavity may extend radially within the carrier from the first inner flange to the first outer flange.

The annular cavity may extend axially within the carrier from the first web to the second section. The annular cavity may also extend radially within the carrier from the second section to the first outer flange.

The blade outer air seal may be mounted to the first section.

The blade outer air seal may also be mounted to the second section.

The first section and the second section may each have a full-hoop monolithic body.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a partial schematic sectional illustration of a turbine engine for an aircraft propulsion system.

FIG. 2 is a partial schematic sectional illustration of a clearance control system arranged with an engine rotor.

FIG. 3 is a schematic end view illustration of the clearance control system.

FIG. 4 is a flow diagram of a method for manufacturing the clearance control system.

FIGS. 5-10 are partial schematic sectional illustrations of the clearance control system with various alternative control ring carrier arrangements.

### DETAILED DESCRIPTION

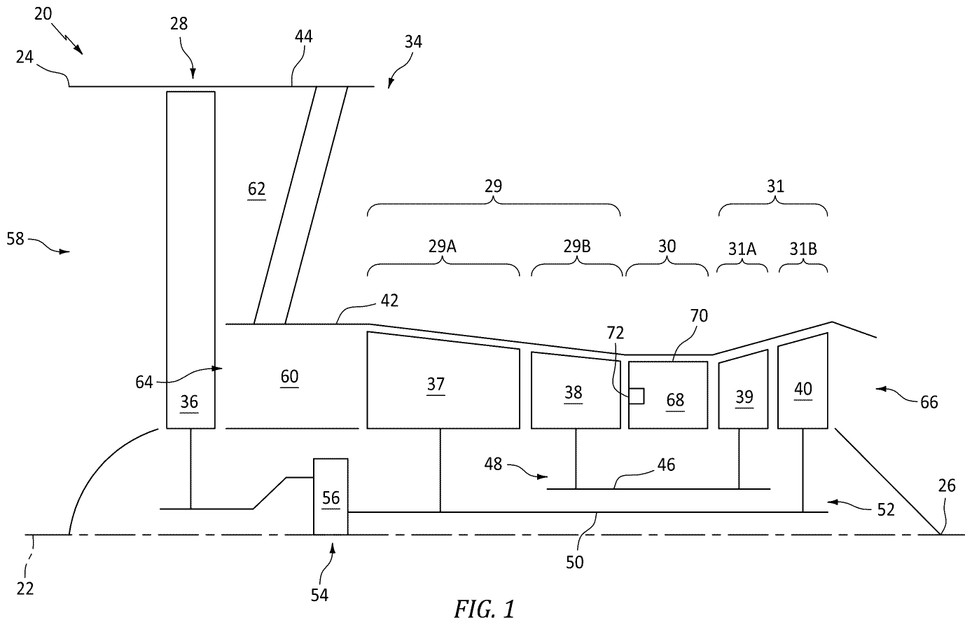

FIG. 1 illustrates a turbine engine 20 for a propulsion system of an aircraft. The aircraft may be an airplane, a drone (e.g., an unmanned aerial vehicle (UAV)), or any other manned or unmanned aerial vehicle or system. For ease of description, the aircraft propulsion system is described below as a turbofan propulsion system, and the turbine engine 20 is described below as a turbofan engine. The present disclosure, however, is not limited to such an exemplary aircraft propulsion system. The aircraft propulsion system, for example, may alternatively be configured as a turbojet propulsion system, a turboprop propulsion system, a turboshaft propulsion system or an open rotor propulsion system. Moreover, the present disclosure is not limited to propulsion system applications. The turbine engine 20, for example, may alternatively be configured as or included as part of an auxiliary power unit (APU) for the aircraft or a ground-based (e.g., industrial) electrical power system.

The turbine engine 20 of FIG. 1 extends axially along an axis 22 between a forward, upstream end 24 of the turbine engine 20 and an aft, downstream end 26 of the turbine engine 20. Briefly, the axis 22 may be a centerline axis of the turbine engine 20 and/or one or more of its members. The axis 22 may also or alternatively be a rotational axis for one or more members of the turbine engine 20. The turbine engine 20 of FIG. 1 includes a propulsor section 28 (e.g., a fan section), a compressor section 29, a combustor section 30 and a turbine section 31. The compressor section 29 of FIG. 1 includes a low pressure compressor (LPC) section 29A and a high pressure compressor (HPC) section 29B. The turbine section 31 of FIG. 1 includes a high pressure turbine (HPT) section 31A and a low pressure turbine (LPT) section 31B.

The engine sections 28-31B may be arranged sequentially along the axis 22 within a stationary engine housing 34. The propulsor section 28 includes a bladed propulsor rotor 36; e.g., a fan rotor. The LPC section 29A includes a bladed low pressure compressor (LPC) rotor 37. The HPC section 29B includes a bladed high pressure compressor (HPC) rotor 38. The HPT section 31A includes a bladed high pressure turbine (HPT) rotor 39. The LPT section 31B includes a bladed low pressure turbine (LPT) rotor 40. These engine rotors 36-40 are housed within the engine housing 34. The engine housing 34 of FIG. 1, for example, includes an inner housing structure 42 (e.g., a core case structure) and an outer housing structure 44 (e.g., a propulsor case structure). The inner housing structure 42 may house one or more of the engine sections 29A-31B and their engine rotors 37-40. The outer housing structure 44 may house at least the propulsor section 28 and its propulsor rotor 36.

The HPC rotor 38 is coupled to and rotatable with the HPT rotor 39. The HPC rotor 38 of FIG. 1, for example, is connected to the HPT rotor 39 through a high speed shaft 46. At least (or only) the HPC rotor 38, the HPT rotor 39 and the high speed shaft 46 collectively form a high speed rotating assembly 48; e.g., a high speed spool of a core of the turbine engine 20. This high speed rotating assembly 48 of FIG. 1 and its members 38, 39 and 46 are rotatable about the axis 22.

The LPC rotor 37 is coupled to and rotatable with the LPT rotor 40. The LPC rotor 37 of FIG. 1, for example, is connected to the LPT rotor 40 through a low speed shaft 50. At least (or only) the LPC rotor 37, the LPT rotor 40 and the low speed shaft 50 collectively form a low speed rotating assembly 52; e.g., a low speed spool of the engine core. This low speed rotating assembly 52 is further coupled to the propulsor rotor 36 through a drivetrain 54. This drivetrain 54 may be configured as a geared drivetrain, where a geartrain 56 (e.g., a transmission, a speed change device, an epicyclic geartrain, etc.) is disposed between and operatively couples the propulsor rotor 36 to the low speed rotating assembly 52 and its LPT rotor 40. With this arrangement, the propulsor rotor 36 may rotate at a different (e.g., slower) rotational velocity than the low speed rotating assembly 52 and its LPT rotor 40. However, the drivetrain 54 may alternatively be configured as a direct drive drivetrain, where the geartrain 56 is omitted. With such an arrangement, the propulsor rotor 36 rotates at a common (the same) rotational velocity as the low speed rotating assembly 52 and its LPT rotor 40. The low speed rotating assembly 52 of FIG. 1 and its members 37, 40 and 50 as well as the propulsor rotor 36 are rotatable about the axis 22.

During operation, ambient air from outside of the aircraft enters the turbine engine 20 through an airflow inlet 58. This air is directed across the propulsor section 28 and into a (e.g., annular) core flowpath 60 and a (e.g., annular) bypass flowpath 62. The core flowpath 60 of FIG. 1 extends sequentially through the LPC section 29A, the HPC section 29B, the combustor section 30, the HPT section 31A and the LPT section 31B from an airflow inlet 64 into the core flowpath 60 to a combustion products exhaust 66 out from the core flowpath 60 and the engine core. The air entering the core flowpath 60 may be referred to as “core air”. The bypass flowpath 62 extends through a bypass duct, which bypass flowpath 62 bypasses (e.g., is disposed radially outboard of and extends along) the engine core. The air within the bypass flowpath 62 may be referred to as “bypass air”.

The core air is compressed by the LPC rotor 37 and the HPC rotor 38 and is directed into a (e.g., annular) combustion chamber 68 of a (e.g., annular) combustor 70 in the combustor section 30. Fuel is injected into the combustion chamber 68 by one or more fuel injectors 72 and mixed with the compressed core air to provide a fuel-air mixture. This fuel-air mixture is ignited and combustion products thereof flow through and sequentially drive rotation of the HPT rotor 39 and the LPT rotor 40 about the axis 22. The rotation of the HPT rotor 39 and the LPT rotor 40 respectively drive rotation of the HPC rotor 38 and the LPC rotor 37 about the axis 22 and, thus, the HPC rotor 38 and the LPC rotor 37 drive compression of the air received from the core inlet 64. The rotation of the LPT rotor 40 also drives rotation of the propulsor rotor 36. The rotation of the propulsor rotor 36 propels the bypass air through and out of the bypass flowpath 62. The propulsion of the bypass air may account for a majority of thrust generated by the turbine engine 20 of FIG. 1, e.g., more than seventy-five percent (75%) of engine thrust. The turbine engine 20 of the present disclosure, however, is not limited to the foregoing exemplary thrust ratio.

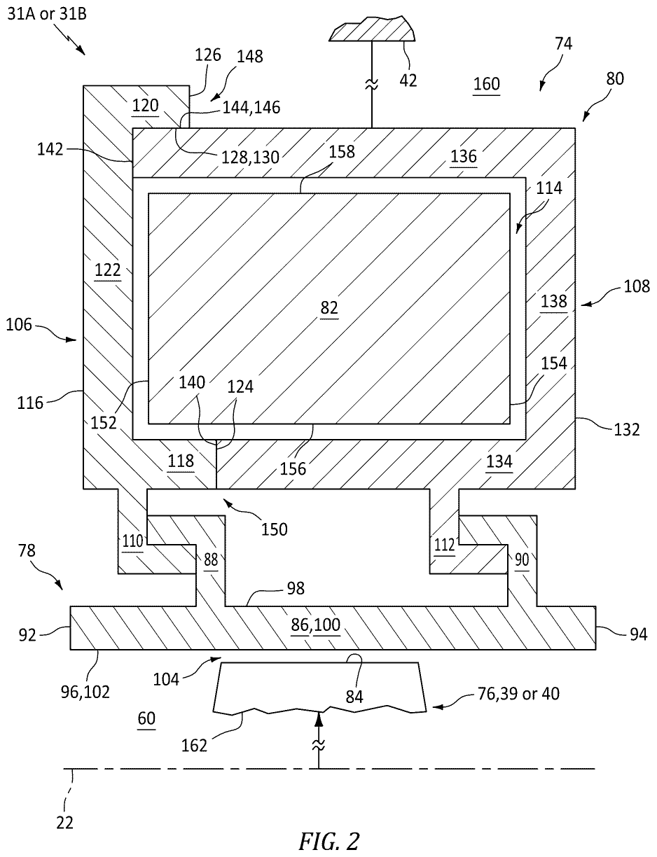

FIG. 2 illustrates a clearance control system 74 arranged with an engine rotor 76, where the clearance control system 74 and the engine rotor 76 are housed within the inner housing structure 42. For ease of description, the clearance control system 74 and the engine rotor 76 are described below as being located along the core flowpath 60 within the turbine section 31. The engine rotor 76, for example, may be configured as or otherwise included as part of the HPT rotor 39. In another example, the engine rotor 76 may be configured as or otherwise included as part of the LPT rotor 40. The present disclosure, however, is not limited to such exemplary arrangements within the turbine section 31. The clearance control system 74 of FIG. 2 includes a blade outer air seal 78 (“BOAS”; sometimes also referred to as an “outer shroud”), a control ring carrier 80 and a control ring 82. Note, for ease of description, the clearance control system 74 and its members 78, 80 and 82 are described below as being coaxial with the axis 22. In other words, the axis 22 may also be a centerline axis of the clearance control system 74 and its members 78, 80 and 82. However, it is contemplated any one or more of the members 78, 80 and/or 82 may alternatively have a centerline axis that is (e.g., slightly) laterally offset from the axis 22. A centerline axis of the members 78, 80 and 82, for example, may be offset radially to one side of the axis 22; however, this centerline axis may still be parallel with the axis 22.

The blade outer air seal 78 is configured to form a radial outer peripheral boundary of the core flowpath 60. The blade outer air seal 78 is also arranged in close proximity to rotor blade tips 84 of the engine rotor 76 to reduce leakage over the rotor blade tips 84 during turbine engine operation. The blade outer air seal 78 of FIG. 2 includes a tubular seal base 86, one or more seal upstream mounts 88 and one or more seal downstream mounts 90.

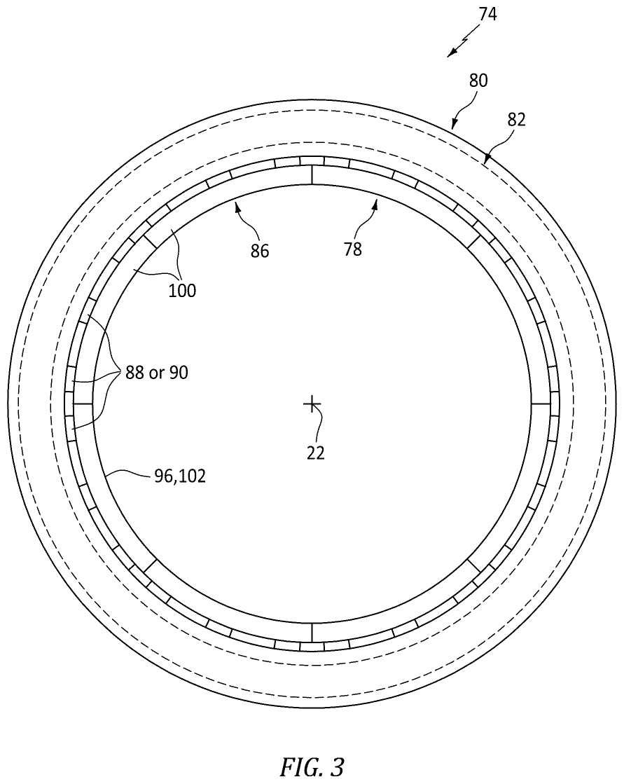

The blade outer air seal 78 and its seal base 86 extend axially along the axis 22/longitudinally along the core flowpath 60 from an upstream end 92 of the blade outer air seal 78 to a downstream end 94 of the blade outer air seal 78. The seal base 86 extends radially from a radial inner side 96 of the blade outer air seal 78 and its seal base 86 to a radial outer side 98 of the seal base 86. Referring to FIG. 3, the blade outer air seal 78 and its seal base 86 extend circumferentially around the axis 22, providing the blade outer air seal 78 and its seal base 86 with a tubular geometry. As best seen in FIG. 3, the seal base 86 and, thus, the blade outer air seal 78 are circumferentially segmented bodies. The seal base 86 of FIG. 3, for example, includes a plurality of base segments 100 arranged circumferentially about the axis 22 end-to-end in an annular array; e.g., a circular array.

The seal base 86 includes a tubular (e.g., cylindrical or frustoconical) flowpath surface 102 at the seal inner side 96. This flowpath surface 102 is formed collectively by the base segments 100 and extends circumferentially around the axis 22. Referring to FIG. 2, the flowpath surface 102 extends axially along the axis 22/longitudinally along the core flowpath 60 from (or about) the seal upstream end 92 to (or about) the seal downstream end 94. The flowpath surface 102 is disposed next to and radially outboard of the engine rotor 76 and its rotor blade tips 84. The flowpath surface 102 thereby extends axially along and circumscribes the engine rotor 76 and its rotor blade tips 84. With this arrangement, the flowpath surface 102 forms the radial outer peripheral boundary of the core flowpath 60 along the blade outer air seal 78. While the flowpath surface 102 of FIG. 2 is radially spaced outward from the engine rotor 76 and its rotor blade tips 84 by a (e.g., slight) radial air gap 104, a radial height of this gap may be minimized by operation of the clearance control system 74 and its members 80 and 82 as described below in further detail.

The seal upstream mounts 88 may be arranged circumferentially about the axis 22 in an annular array, where each base segment 100 may be associated with one or more of the seal upstream mounts 88. Each seal upstream mount 88 is connected to (e.g., formed integral with or otherwise attached to) the respective base segment 100. Each seal upstream mount 88 is disposed at (e.g., on, adjacent or proximate) or near the seal upstream end 92. Each seal upstream mount 88 may be configured as an upstream hook. Here, the upstream hook is facing upstream. However, in other embodiments, the upstream hook may alternatively face downstream.

The seal downstream mounts 90 may be arranged circumferentially about the axis 22 in an annular array, where each base segment 100 may be associated with one or more of the seal downstream mounts 90. Each seal downstream mount 90 is connected to the respective base segment 100. Each seal downstream mount 90 is disposed axially between a respective one of the seal upstream mounts 88 and the seal downstream end 94. Each seal downstream mount 90 may be configured as a downstream hook. Here, the downstream hook is facing upstream. However, in other embodiments, the downstream hook may alternatively face downstream.

The ring carrier 80 includes a carrier upstream section 106, a carrier downstream section 108, one or more (e.g., arcuate) carrier upstream mounts 110 and one or more (e.g., arcuate) carrier downstream mounts 112. The ring carrier 80 also includes an internal carrier cavity 114 (e.g., a sealed cavity) within the ring carrier 80 and formed (e.g., only or substantially) by the carrier upstream section 106 and the carrier downstream section 108.

The carrier upstream section 106 is disposed at an axial upstream end 116 of the ring carrier 80. The carrier upstream section 106 of FIG. 2 has a channeled sectional geometry when viewed, for example, in a reference plane parallel to (e.g., including) the axis 22. The carrier upstream section 106 of FIG. 2, for example, includes an upstream section inner flange 118, an upstream section outer flange 120 and an upstream section web 122. The carrier upstream section 106 and each of its members 118, 120, 122 extends circumferentially uninterrupted around the axis 22, providing the carrier upstream section 106 and each of its members 118, 120, 122 with a full-hoop geometry. For example, each of the upstream section flanges 118, 120 may have a tubular geometry and the upstream section web 122 may have an annular geometry.

The upstream section inner flange 118 projects axially along the axis 22 from the carrier upstream end 116 to an axial distal end 124 of the upstream section inner flange 118.

The upstream section outer flange 120 is spaced radially outboard from the upstream section inner flange 118. The upstream section outer flange 120 projects axially along the axis 22 from the carrier upstream end 116 to an axial distal end 126 of the upstream section outer flange 120. The upstream section outer flange 120 thereby (e.g., partially) axially overlaps the upstream section inner flange 118. Here, the distal end 126 of the upstream section outer flange 120 may be axially recessed from the distal end 124 of the upstream section inner flange 118. The upstream section outer flange 120 of FIG. 2 includes an upstream section engagement surface 128 at a radial inner side 130 of the upstream section outer flange 120. This upstream section engagement surface 128 extends axially from the upstream section web 122 to the distal end 126 of the upstream section outer flange 120. The upstream section engagement surface 128 extends circumferentially uninterrupted around the axis 22, providing the upstream section engagement surface 128 with a full-hoop (e.g., cylindrical) geometry.

The upstream section web 122 is disposed at the carrier upstream end 116. The upstream section web 122 extends radially between and is connected to the upstream section inner flange 118 and the upstream section outer flange 120.

The carrier downstream section 108 is disposed at an axial downstream end 132 of the ring carrier 80, where the carrier downstream end 132 is axially opposite the carrier upstream end 116. The carrier downstream section 108 of FIG. 2 has a channeled sectional geometry when viewed, for example, in the reference plane. The carrier downstream section 108 of FIG. 2, for example, includes a downstream section inner flange 134, a downstream section outer flange 136 and a downstream section web 138. The carrier downstream section 108 and each of its members 134, 136, 138 extends circumferentially uninterrupted around the axis 22, providing the carrier downstream section 108 and each of its members 134, 136, 138 with a full-hoop geometry. For example, each of the downstream section flanges 134, 136 may have a tubular geometry and the downstream section web 138 may have an annular geometry.

The downstream section inner flange 134 projects axially along the axis 22 from the carrier downstream end 132 to an axial distal end 140 of the downstream section inner flange 134.

The downstream section outer flange 136 is spaced radially outboard from the downstream section inner flange 134. The downstream section outer flange 136 projects axially along the axis 22 from the carrier downstream end 132 to an axial distal end 142 of the downstream section outer flange 136. The downstream section outer flange 136 thereby axially overlaps (e.g., an entirety of) the downstream section inner flange 134. Here, the distal end 140 of the downstream section inner flange 134 is axially recessed from the distal end 142 of the downstream section outer flange 136. The downstream section outer flange 136 of FIG. 2 includes a downstream section engagement surface 144 at a radial outer side 146 of the downstream section outer flange 136. This downstream section engagement surface 144 extends axially to the distal end 142 of the downstream section outer flange 136. The downstream section engagement surface 144 extends circumferentially uninterrupted around the axis 22, providing the downstream section engagement surface 144 with a full-hoop (e.g., cylindrical) geometry.

The downstream section web 138 is disposed at the carrier downstream end 132. The downstream section web 138 extends radially between and is connected to the downstream section inner flange 134 and the downstream section outer flange 136.

The carrier downstream section 108 is mated with the carrier upstream section 106. The downstream section outer flange 136 of FIG. 2, for example, is coupled to the upstream section outer flange 120 at an outer coupling 148 located radially outboard of and axially aligned with the carrier cavity 114. This outer coupling 148 of FIG. 2 is configured as a sealed full-hoop mechanical joint between the carrier downstream section 108 and the carrier upstream section 106. For example, at the outer coupling 148, the downstream section outer flange 136 is arranged with the upstream section outer flange 120 to provide an axial overlap joint between the downstream section outer flange 136 and the upstream section outer flange 120. Here, the upstream section engagement surface 128 axially overlaps and is radially outboard of the downstream section engagement surface 144. The upstream section engagement surface 128 may also (or alternately) radially engage the downstream section engagement surface 144 to provide a (e.g., slight) interference fit connection between the upstream section outer flange 120 and the downstream section outer flange 136. The outer coupling 148 may thereby be sealed such that little or no fluid may leak across the outer coupling 148 between the downstream section outer flange 136 and the upstream section outer flange 120. Here, the distal end 142 of the downstream section outer flange 136 may (or may not) also axially engage the upstream section web 122.

The downstream section inner flange 134 of FIG. 2 is coupled to the upstream section inner flange 118 at an inner coupling 150 located radially inboard of and axially aligned with the carrier cavity 114. This inner coupling 150 of FIG. 2 is configured as a sealed full-hoop weld joint between the carrier downstream section 108 and the carrier upstream section 106. This sealed full-hoop weld joint is axially between the downstream section inner flange 134 and the upstream section inner flange 118. The inner coupling 150 may thereby be sealed such that little or no fluid may leak across the inner coupling 150 between the downstream section inner flange 134 and the upstream section inner flange 118.

The carrier cavity 114 extends axially within the ring carrier 80 between and is formed by the upstream section web 122 and the downstream section web 138. A first portion of the carrier cavity 114 extends radially within the ring carrier 80 between and is formed by (a) the upstream section inner flange 118 and (b) a portion of the downstream section outer flange 136 adjacent the upstream section web 122. A second portion of the carrier cavity 114 extends radially within the ring carrier 80 between and is formed by (a) the downstream section inner flange 134 and (b) a portion of the downstream section outer flange 136 adjacent the downstream section web 138. The carrier cavity 114 extends within the ring carrier 80 circumferentially around the axis 22, providing the carrier cavity 114 with a full-hoop (e.g., annular) geometry.

The carrier upstream mounts 110 may be arranged circumferentially about the axis 22 in an annular array. Each carrier upstream mount 110 of FIG. 2 is connected to the carrier upstream section 106 and its upstream section inner flange 118. Each carrier upstream mount 110 may be configured as an upstream hook. Here, the upstream hook is facing downstream. However, in other embodiments, the upstream hook may alternatively face upstream. Each carrier upstream mount 110 is mated with a respective one of the seal upstream mounts 88. The carrier upstream mounts 110 and the seal upstream mounts 88 thereby attach the blade outer air seal 78 and its base segments 100 to the ring carrier 80 and its carrier upstream section 106, for example, independent of the carrier downstream section 108.

The carrier downstream mounts 112 may be arranged circumferentially about the axis 22 in an annular array. Each carrier downstream mount 112 of FIG. 2 is connected to the carrier downstream section 108 and its downstream section inner flange 134. Each carrier downstream mount 112 may be configured as a downstream hook. Here, the downstream hook is facing downstream. However, in other embodiments, the downstream hook may alternatively face upstream. Each carrier downstream mount 112 is mated with a respective one of the seal downstream mounts 90. The carrier downstream mounts 112 and the seal downstream mounts 90 thereby attach the blade outer air seal 78 and its base segments 100 to the ring carrier 80 and its carrier downstream section 108, for example, independent of the carrier upstream section 106.

The ring carrier 80 may mount the blade outer air seal 78 and its base segments 100 to the inner housing structure 42. The carrier downstream section 108 (or the carrier upstream section 106), for example, may be attached to the inner housing structure 42.

The control ring 82 extends axially along the axis 22 between opposing axial ends 152 and 154 of the control ring 82. The control ring 82 extends radially from a radial inner side 156 of the control ring 82 to a radial outer side 158 of the control ring 82. The control ring 82 is disposed within the carrier cavity 114. The control ring 82 extends within the carrier cavity 114 circumferentially around the axis 22, providing the control ring 82 with a full-hoop (e.g., annular) geometry. Note, it is contemplated that the control ring 82 may include one or more non-axisymmetric features and/or interfaces without compromising its full-hoop geometry.

During turbine engine operation, air bled from the compressor section 29 (see FIG. 1) may be directed into a plenum 160 surrounding the ring carrier 80. A temperature of this bleed air influences thermal expansion and contraction of the ring carrier 80. A temperature of the combustion products flowing through the core flowpath 60 similarly influences thermal expansion and contraction of the engine rotor 76 and its rotor blades 162. However, whereas a disk of the engine rotor 76 has a relatively large mass and is relatively thick, the ring carrier 80 has a relatively small mass with relatively thin walls. The ring carrier 80 therefore may thermally expand faster than the engine rotor 76 during a rapid engine power increase. Similarly, the ring carrier 80 may thermally contract faster than the engine rotor 76 during a rapid engine power decrease. This differential thermal expansion/contraction rate between the ring carrier 80 and the engine rotor 76 (if unmitigated) may increase leakage over the rotor blade tips 84 or increase likelihood of contact between the rotor blade tips 84 and the blade outer air seal 78. However, the control ring 82 is provided to control inward thermally induced movement of the blade outer air seal 78 and its base segments 100. The carrier cavity 114, for example, is substantially or completely fluidly discrete from the plenum 160 next to and surrounding the ring carrier 80. The control ring 82 therefore may be exposed to higher or lower temperatures at a slower rate than the ring carrier 80 during transient engine operation. Moreover, the relatively large mass of the control ring 82 decreases its thermal growth rate. Here, the control ring 82 may be tuned such that when the ring carrier 80 starts to shrink the control ring 82 may engage the ring carrier 80 to keep the ring carrier 80 outboard and prevent the rotor blades from striking the blade outer air seal 78 during a hot re-burst event. The control ring 82 may thereby radially engage the downstream section outer flange 136 and limit the inward movement of the blade outer air seal 78 and its base segments 100 during the rapid engine power decrease.

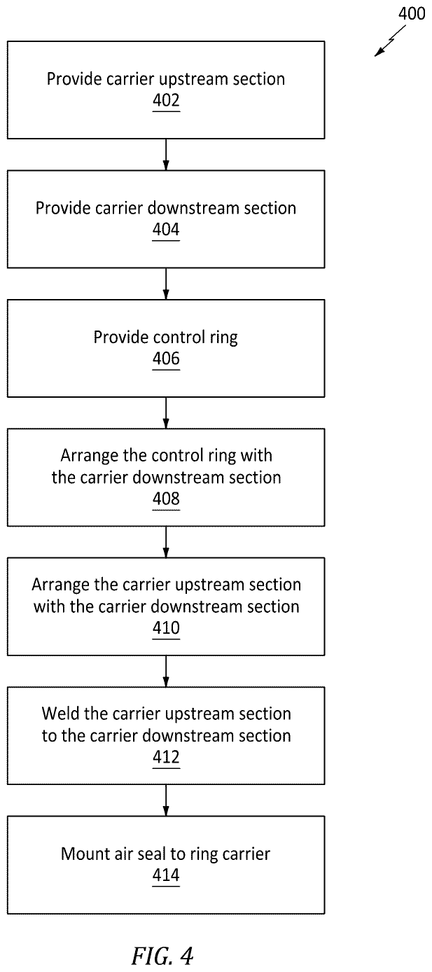

FIG. 4 is a flow diagram of a method 400 for manufacturing a clearance control system. For ease of description, the manufacturing method 400 is described below with reference to the clearance control system 74 described above and illustrated in FIGS. 2 and 3. The manufacturing method 400, however, is not limited to such an exemplary arrangement. The manufacturing method 400, for example, may alternatively be performed to manufacture any of the clearance control system arrangements described further below.

In step 402, the carrier upstream section 106 is provided. The carrier upstream section members (e.g., 110, 118, 120 and 122), for example, may be cast, machined, additively manufactured and/or otherwise formed as a single, unitary body. The carrier upstream section 106 may thereby be configured as or otherwise include a full-hoop monolithic body. The present disclosure, however, is not limited to such an exemplary carrier upstream section formation process. In other embodiments, for example, it is contemplated the carrier upstream section 106 may alternatively include multiple discretely formed parts which are attached (e.g., welded or otherwise bonded) together following the formation thereof. The carrier upstream section 106 may thereby be configured as a non-monolithic body.

In step 404, the carrier downstream section 108 is provided. The carrier downstream section members (e.g., 112, 134, 136 and 138), for example, may be cast, machined, additively manufactured and/or otherwise formed as a single, unitary body. The carrier downstream section 108 may thereby be configured as or otherwise include a full-hoop monolithic body. The present disclosure, however, is not limited to such an exemplary carrier downstream section formation process. In other embodiments, for example, it is contemplated the carrier downstream section 108 may alternatively include multiple discretely formed parts which are attached (e.g., welded, brazed and/or otherwise bonded) together following the formation thereof. The carrier downstream section 108 may thereby be configured as a non-monolithic body.

In step 406, the control ring 82 is provided. The control ring 82, for example, may be cast, machined, additively manufactured and/or otherwise formed as a single, unitary body. The control ring 82 may thereby be configured as or otherwise include a full-hoop monolithic body. The present disclosure, however, is not limited to such an exemplary control ring formation process. In other embodiments, for example, it is contemplated the control ring 82 may alternatively include multiple discretely formed parts which are mechanically fastened (e.g., bolted, riveted, etc.), bonded (e.g., welded, brazed, etc.) and/or otherwise attached together following the formation thereof. The control ring 82 may thereby be configured as a non-monolithic body.

In step 408, the control ring 82 is arranged in a channel of the carrier downstream section 108. The control ring 82, for example, may be axially translated relative to the carrier downstream section 108 to locate the control ring 82 in the channel of the carrier downstream section 108. Here, the channel forms a portion of the to-be-formed carrier cavity 114.

In step 410, the carrier upstream section 106 is arranged with the carrier downstream section 108. The carrier upstream section 106, for example, may be heated to a higher temperature than the carrier downstream section 108 and/or the carrier downstream section 108 may be cooled to a lower temperature than the carrier upstream section 106 such that a radius of the upstream section engagement surface 128 is slightly larger than a radius of the downstream section engagement surface 144. The carrier upstream section 106 may then be axially translated relative to the carrier downstream section 108 until, for example, the distal end 124 of the upstream section inner flange 118 axially engages (e.g., abuts against) the distal end of the downstream section inner flange 134. As the temperature differential between the carrier upstream section 106 and the carrier downstream section 108 decreases or goes to zero, the upstream section engagement surface 128 radially engages the downstream section engagement surface 144 as described above to provide the outer coupling 148; e.g., the sealed full-hoop mechanical joint between the carrier upstream section 106 and the carrier downstream section 108. By providing this outer coupling 148 between the carrier upstream section 106 and the carrier downstream section 108, the carrier upstream section 106 is self-fixtured with the carrier downstream section 108 for a subsequent welding operation. More particularly, a subsequent welding operation may be performed without use of a fixture or other such devices to locate and hold the carrier upstream section 106 and the carrier downstream section 108 relative to one another. Note, even without the interference fit between the upstream section engagement surface 128 and the downstream section engagement surface 144 the axial and radial engagement between the carrier upstream section 106 and the carrier downstream section 108 may provide the self-fixturing.

In step 412, the carrier upstream section 106 is welded to the carrier downstream section 108 to provide the inner coupling 150. The upstream section inner flange 118, for example, may be welded to the downstream section inner flange 134 proximate their distal ends 124 and 140 to provide the sealed full-hoop weld joint between the carrier downstream section 108 and the carrier upstream section 106. This welding may be performed via a laser welding technique or an electron beam (EB) welding technique so as to reduce thermal distortion during the welding. The present disclosure, however, is not limited to such exemplary welding techniques. The welding, for example, may alternatively be performed via a tungsten inert gas (TIG) welding technique or a metal inert gas (MIG) welding technique. Alternatively, it is contemplated the carrier upstream section 106 may be brazed to the carrier downstream section 108 to provide the inner coupling 150.

In step 414, the blade outer air seal 78 and its base segments 100 are mounted to the ring carrier 80.

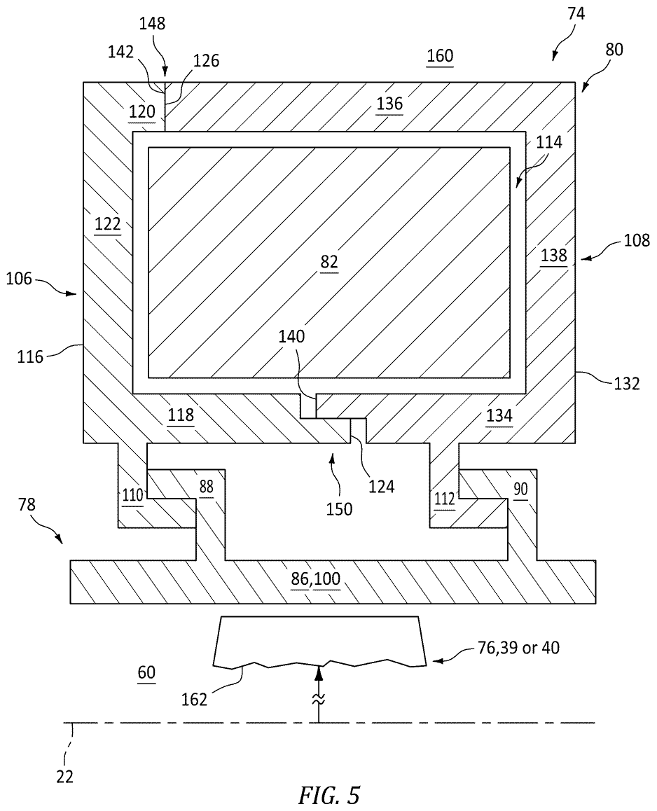

In some embodiments, referring to FIG. 2, the outer coupling 148 may be configured as the sealed full-hoop mechanical joint between the carrier upstream section 106 and the carrier downstream section 108, and the inner coupling 150 may be configured as the sealed full-hoop weld joint between the carrier downstream section 108 and the carrier upstream section 106. In other embodiments, referring to FIG. 5, the outer coupling 148 may alternatively be configured as the sealed full-hoop weld joint between the carrier downstream section 108 and the carrier upstream section 106, and the inner coupling 150 may alternatively be configured as the sealed full-hoop mechanical joint between the carrier upstream section 106 and the carrier downstream section 108.

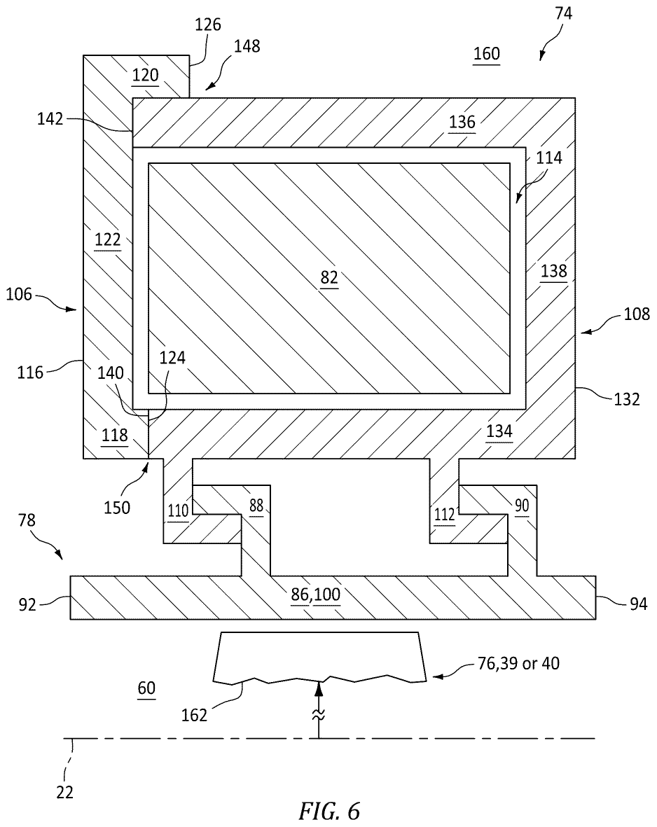

In some embodiments, referring to FIGS. 2 and 5, the inner coupling 150 may be located axially between the carrier upstream mount 110 and the carrier downstream mount 112. With such an arrangement, the carrier upstream mount 110 is configured as part of the carrier upstream section 106. The carrier downstream mount 112 is configured as part of the carrier downstream section 108. In other embodiments, referring to FIG. 6, the inner coupling 150 may be located axially between the carrier upstream mount 110 and the carrier upstream end 116. With such an arrangement, the carrier upstream mount 110 and the carrier downstream mount 112 are both configured as part of the carrier downstream section 108.

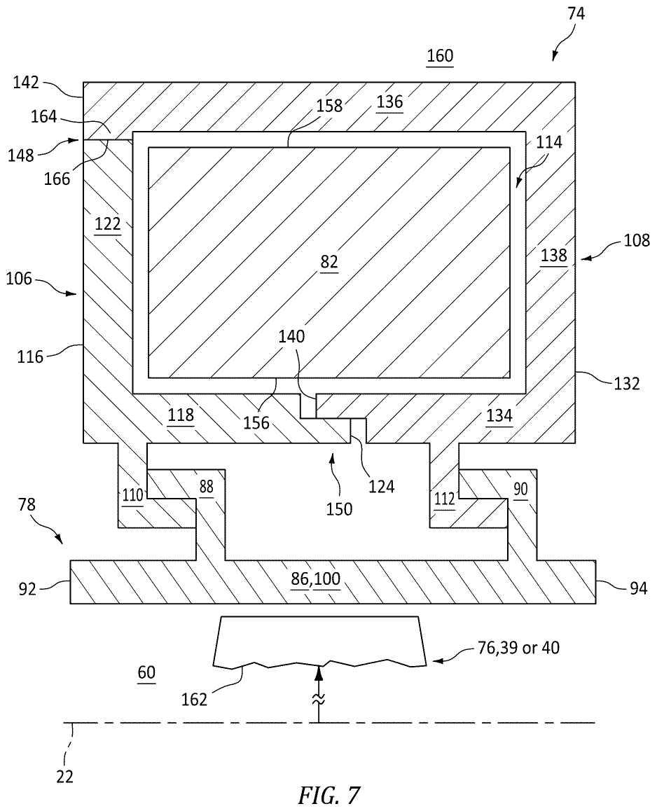

In some embodiments, referring to FIG. 5, the outer coupling 148 may be axially aligned with and radially outboard of the carrier cavity 114 and the control ring 82. In other embodiments, referring to FIG. 7, the outer coupling 148 may be radially aligned with and axially next to the carrier cavity 114, where the outer coupling 148 may be radially inline with or radially outboard of the outer side 158 of the control ring 82 to facilitate assembly of the control ring 82 into the carrier cavity 114. Here, the carrier upstream section 106 omits the upstream section outer flange 120, and the carrier downstream section 108 further includes a flange rim 164. The flange rim 164 is disposed at the end 142 of the downstream section outer flange 136, and the flange rim 164 projects radially inward from the downstream section outer flange 136 to an inner distal end 166 of the flange rim 164. At the outer coupling 148 of FIG. 7, the flange rim 164 radially engages and is welded to the upstream section web 122 to provide the sealed full-hoop weld joint between the carrier downstream section 108 and the carrier upstream section 106.

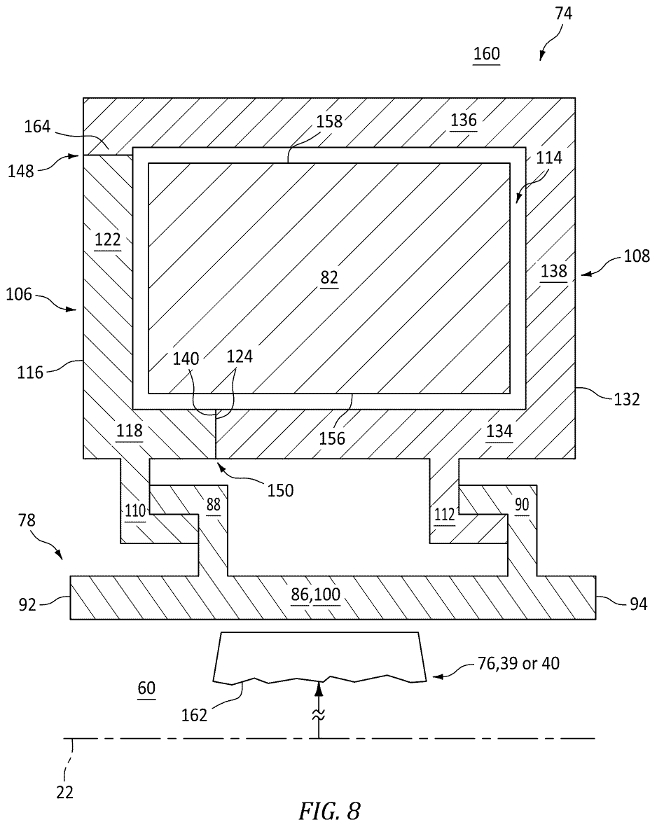

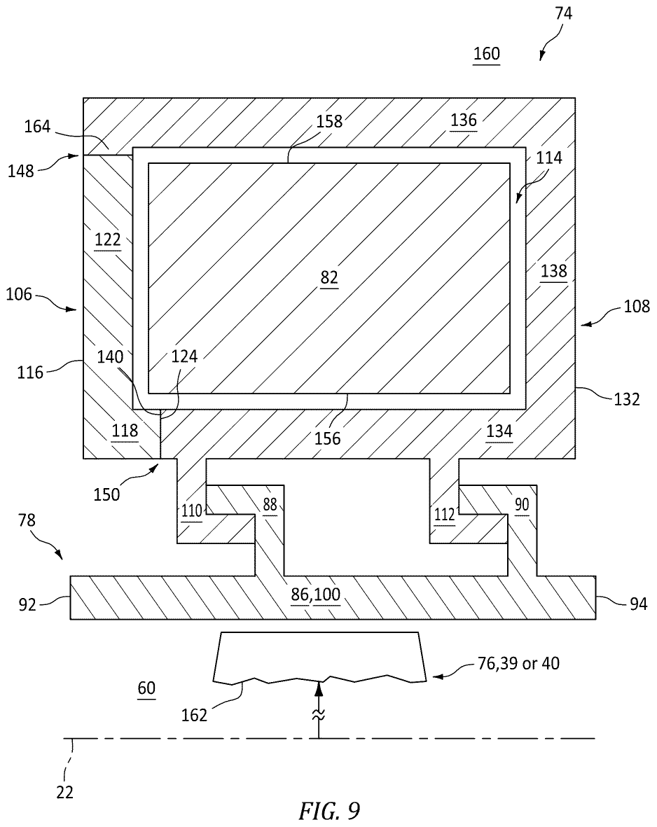

As described above, one of the carrier couplings 148, 150 may be a sealed full-hoop weld/braze joint between the carrier downstream section 108 and the carrier upstream section 106, and the other one of the carrier couplings 150, 148 may be a sealed full-hoop mechanical joint between the carrier downstream section 108 and the carrier upstream section 106. With such an arrangement, the carrier downstream section 108 and the carrier upstream section 106 may be mechanically coupled (e.g., snapped together) prior to welding/brazing. In addition, a one-way leakage path may be provided between the carrier downstream section 108 and the carrier upstream section 106 through the sealed full-hoop mechanical joint when, for example, there is a relatively high pressure differential between air in the carrier cavity 114 and air in the plenum 160. The present disclosure, however, is not limited to such exemplary coupling arrangements between the carrier downstream section 108 and the carrier upstream section 106. For example, referring to FIGS. 8 and 9, both of the carrier couplings 148 and 150 may be sealed full-hoop weld joints between the carrier downstream section 108 and the carrier upstream section 106. With the arrangements of FIGS. 8 and 9, the outer coupling 148 may be radially inline with or radially outboard of the outer side 158 of the control ring 82 to facilitate assembly of the control ring 82 into the carrier cavity 114.

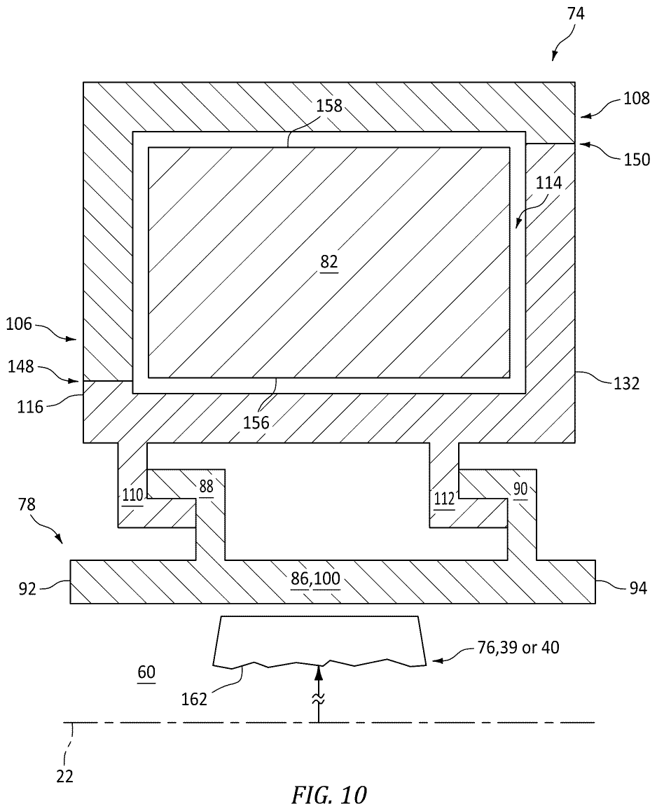

In some embodiments, referring to FIG. 10, the carrier couplings 148 and 150 may be disposed to the opposing axial ends 116 and 132 of the ring carrier 80. Each carrier coupling 148, 150 of FIG. 10 is radially aligned with and axially next to the carrier cavity 114. The carrier coupling 148 may be radially inline with or radially inboard of the inner side 156 of the control ring 82, and the carrier coupling 150 may be radially inline with or radially outboard of the outer side 158 of the control ring 82 to facilitate assembly of the control ring 82 into the carrier cavity 114, or vice versa.

In some embodiments, it is contemplated one of the carrier sections 106, 108 may (or may not) include one or more (e.g., small) vent holes.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

1. An assembly for a turbine engine, comprising:
a carrier extending circumferentially around an axis, the carrier including an annular cavity, a first section and a second section, the annular cavity formed within the carrier by the first section and the second section, the first section welded and/or brazed to the second section at a sealed full-hoop bond joint, and the first section further connected to the second section at a second sealed full-hoop joint;
a control ring extending circumferentially around the axis within the annular cavity; and
a blade outer air seal mounted to the first section of the carrier and the second section of the carrier.

2. The assembly of claim 1, wherein the carrier fluidly separates the annular cavity from a plenum next to and/or around the carrier.

3. The assembly of claim 1, wherein the sealed full-hoop bond joint is radially outboard of the annular cavity.

4. The assembly of claim 3, wherein the second sealed full-hoop joint is radially inboard of the annular cavity.

5. The assembly of claim 1, wherein the sealed full-hoop bond joint is radially inboard of the annular cavity.

6. The assembly of claim 5, wherein the second sealed full-hoop joint is radially outboard of the annular cavity.

7. The assembly of claim 5, wherein the second sealed full-hoop joint is radially aligned with and to an axial side of the annular cavity.

8. The assembly of claim 1, wherein the sealed full-hoop bond joint is radially aligned with and to a first axial side of the annular cavity.

9. The assembly of claim 8, wherein the second sealed full-hoop joint is radially inboard of the annular cavity.

10. The assembly of claim 8, wherein the second sealed full-hoop joint is radially aligned with and to a second axial side of the annular cavity.

11. The assembly of claim 1, wherein the first section is welded and/or brazed to the second section at the second sealed full-hoop joint, and the second sealed full-hoop joint is a second sealed full-hoop bond joint.

12. The assembly of claim 1, wherein the second sealed full-hoop joint comprises a lap joint between the first section and the second section.

13. The assembly of claim 1, wherein the second sealed full-hoop joint comprises an interference fit connection between the first section and the second section.

14. The assembly of claim 1, wherein
the first section includes a first inner flange, a first outer flange and a first web extending radially between and connected to the first inner flange and the first outer flange; and
the annular cavity extends axially within the carrier to the first web, and the annular cavity extends radially within the carrier from the first inner flange to the first outer flange.

15. The assembly of claim 14, wherein
the annular cavity extends axially within the carrier from the first web to the second section; and
the annular cavity further extends radially within the carrier from the second section to the first outer flange.

16. (canceled)

17. (canceled)

18. The assembly of claim 1, wherein the first section and the second section each have a full-hoop monolithic body.

19. An assembly for a turbine engine, comprising:
a carrier extending circumferentially around an axis, the carrier including a cavity, a first section and a second section, the cavity formed within the carrier by the first section and the second section, the first section welded and/or brazed to the second section at a sealed full-hoop bond joint, and the first section attached to the second section at an interference fit connection between the first section and the second section; and
a control ring extending circumferentially around the axis within the cavity.

20. A method of manufacture, comprising:
arranging a control ring in a channel of a carrier first section;
arranging a carrier second section with the carrier first section, the carrier second section axially and radially engaging the carrier first section so as to self-fixture the carrier first section with the carrier second section for subsequent welding and/or brazing; and
welding and/or brazing the carrier second section to the carrier first section to provide a sealed full-hoop bond joint between the carrier second section and the carrier first section, wherein the control ring extends circumferentially around an axis within an annular cavity of a carrier, and the cavity is formed within the carrier by the carrier first section and the carrier second section.
